(19) United States
(12) Patent Application Publication
(10) Pub. No.: US 2022/0053175 A1
(43) Pub. Date: Feb. 17, 2022

(54) METHOD FOR PROJECTING AN IMAGE ONTO A SURFACE AND OVERHEAD SUPPORT STRUCTURE

(71) Applicant: Vestel Elektronik Sanayi ve Ticaret A.S., Manisa (TR)

(72) Inventors: Onur ULUAG, Manisa (TR); Kagan BAKANOGLU, Manisa (TR)

(21) Appl. No.: 17/275,463

(22) PCT Filed: Sep. 13, 2018
(86) PCT No.: PCT/EP2018/074727

§ 371 Date: Mar. 11, 2021

(51) Int. Cl. H04N 9/31; A47J 36/38

(52) U.S. Cl. CPC H04N 9/3194; H04N 9/3185; A47J 36/38; H04N 9/3147

(57) ABSTRACT

Overhead support structure is provided for mounting above a surface. The overhead support structure supports at least one projector for projecting an image onto a surface above which the overhead support structure is mounted, in use. At least sensor is provided to sense such a surface. The at least one image projector is arranged to project an image onto a region selected according to an output of the at least one sensor. The at least one sensor may be arranged to sense the location of an object on such a surface and the at least one projector is configurable to project an image onto a region selected according to a sensed location of one or more objects on such a surface. The selected region may be changed according to a change in the sensed location of one or more objects on such a surface.

### TECHNICAL FIELD

The present disclosure relates to a method for projecting an image onto a surface and to an overhead support structure for projecting an image onto a surface.

### BACKGROUND

It is known to project images, including cooking instructions for example, onto a screen in a kitchen so that those images are visible to a person working in the kitchen.

### SUMMARY

According to a first aspect disclosed herein, there is provided an overhead support structure comprising:
at least one projector for projecting an image onto a surface above which the overhead support structure is mounted in use; and
at least one sensor for sensing a said surface,
wherein the at least one projector is arranged to project an image onto a region selected according to an output of the at least one sensor.

Such an arrangement enables various sensed conditions to be used to determine which regions of the surface, or of an object placed upon the surface, are available to display projected images, including video images, selected by a user.

In an example, the at least one sensor is arranged to sense the location of an object on a said surface and the at least one projector is configurable to project an image onto a region selected according to a sensed location of one or more objects on a said surface. This ensures that an image may be projected onto a region where the image may be seen, taking account of the presence of a 3D object that has been placed on the surface. The region selected may be a region that avoids objects placed upon the surface or a region of an object itself.

In an example, the at least one projector is configurable to project the image onto a different region selected according to a change in the sensed location of one or more objects on a said surface. This enables the image projectors to be reconfigured dynamically according to any change in the sensed location of an object on the surface.

In an example, the at least one projector is configurable to adjust a size or a shape of a projected image according to a determined configuration of the selected region.

In an example, the overhead support structure is arranged such that the configuration of the selected region is determined according to an output of the at least one sensor. That is, the configuration of the selected region may be predetermined or the configuration of the selected region may be determined according to an output of the sensor.

In an example, the selected region is a region of a said surface. Alternatively, or in addition, the selected region is a region of a surface of an object upon a said surface. This enables surfaces of objects also to be used for display of projected images.

In an example, the overhead support structure comprises a plurality of projectors each configurable to project a different image onto each of a plurality of said selected regions.

In an example, the at least one sensor comprises a camera arranged to capture an image of a said surface. Such an image includes an image of any objects upon the surface.

In an example, the overhead support structure comprises an interface for receiving image data defining an image to be projected.

In an example, the overhead support structure comprises an interface to enable remote configuration of the at least one projector.

In an example application, the overhead support structure is an extractor hood for a cooker.

According to a second aspect disclosed herein, there is provided a method for projecting an image from an overhead position, the method comprising:
sensing a surface below the overhead position with a sensor; and
projecting an image onto a region selected according to an output of the sensor.

In an example, the method comprises:
sensing the location of an object on the surface; and
projecting an image onto a region selected according to a sensed location of one or more objects on the surface.

In an example, the method comprises:
projecting the image onto a different region selected according to a change in the sensed location of one or more objects on the surface.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example arrangement of components according to the present disclosure for projecting images onto a cooking surface; and

FIG. 2 is a flow chart for a process according to an example disclosed herein for operating the arrangement shown in FIG. 1.

### DETAILED DESCRIPTION

It is often useful when carrying out activities such as cooking and other crafts to have access to instructions, for example recipes, relevant to the activity. It may be desirable to be presented with multi-media entertainment while carrying out the activity, in addition or instead. As an alternative to paper-based instructions and recipes, for example, it may be more convenient to have the same instructions presented as displayed images, including video images, and optionally to hear sound, close to where the activities are being carried out. It may be yet more convenient to have those images projected, from an overhead source, onto a surface where or near to where the activities are being carried out.

Considering the particular example of cooking, the cooking surface may comprise a glass ceramic surface of an induction cooker or ceramic cooker, or a metal or other surface of a gas cooker or electric cooker (i.e. a cooker having electrically resistive heating elements), for example, providing a good surface on which to display projected images. However, the available surface area for display of projected images is likely to vary according to which parts of the cooking surface are required for the placement of pans, etc.

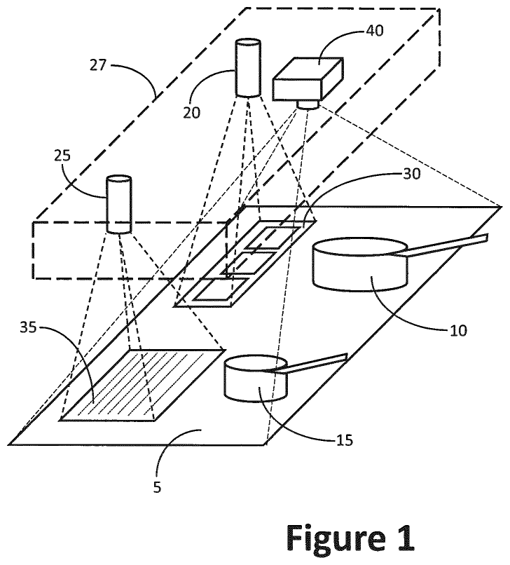

An example arrangement according to the present disclosure will now be described with reference to FIG. 1 in a particular application in which a cooker provides a surface onto which images, including video images, may be projected while a user is using the cooker. Such a surface may in effect be two dimensional and allow two dimensional images to be projected and displayed. Particular types of cooking vessel or other objects may also provide a suitable surface onto which images may be projected, which may in general may allow two dimensional or three dimensional images to be projected and displayed.

Referring to FIG. 1, a cooker has a cooking surface 5 having multiple heating elements (not shown in FIG. 1) mounted beneath the cooking surface 5. The cooker may be for example an induction cooker, a ceramic cooker, a gas cooker, an electric cooker (i.e. a cooker having electrically resistive heating elements), etc. Pans 10, 15 or other types of cooking vessel may be placed over the heating elements for heating. Two image projectors 20, 25 are mounted on a support structure 27 such as an extractor hood or in the base of a wall-mounted cupboard as would typically be mounted above the head of a user of the cooker. Each image projector 20, 25 is oriented to project an image, including video images, onto a respective region 30, 35 of the cooking surface 5.

The size and configuration of each region 30, 35 is determined, at least in part, according to the location of pans 10, 15 or other objects upon the surface 5. At least one sensor 40 is provided for sensing the surface 5. In this example, the sensor 40 is provided as a camera 40, mounted above the cooking surface 5, and positioned to capture images of the cooking surface 5. Image data output by the camera 40 may be communicated to a controller (not shown) for analysis. For example, the image data output by the camera 40 may be analysed to determine the location of any pans 10, 15 or other objects upon the surface 5. With this information, the size and location of an available region 30, 35 may be determined for displaying projected images. The available region may be a region 30, 35 that avoids the pans 10, 15 or other objects, as shown in FIG. 1. Alternatively, the available region may be the lid of a pan 10, 15 or a surface of another object placed on the surface 5, for example a pan 10, 15 or other object. The surface onto which the image is projected may in general be flat or at least having a relatively flat or may be three-dimensional (such as a curved surface or surfaces of a real, three-dimensional object).

The camera 40 may optionally be mounted on the same support structure 27, for example a cooker extractor hood, that supports the image projectors 20, 25.

The image projectors 20, 25 may be configured to project images of a variable size onto different regions 30, 35 of the surface 5 or of one or more objects placed upon the surface 5. The image projectors 20, 25 may also be configured to project images of a variable shape onto different regions 30, 35 of the surface 5 or of one or more objects placed upon the surface 5. The size and/or shape of an image to be projected may be adjusted to correspond with the size and/or shape of an available region 30, 35 determined by an analysis of image data output by the camera 40. Furthermore, the image data output by the camera 40 may be analysed regularly, with a predetermined frequency, to monitor movement of objects placed upon the surface 5 or to identify the location of objects newly placed upon the surface 5. The image projectors 20, 25 may be reconfigured to adjust the size and/or the shape of the projected images according to the determined size and/or shape of the available regions 30, 35, should any object be moved on the surface 5. That is, an available region 30, 35 may increase or decrease in size or may change in shape according to the changing positions of objects on the surface 5, or according to the addition, replacement or removal of objects such as pans 10, 15. The image projectors 20, 25 may be reconfigured accordingly.

The orientation of one or more of the image projectors 20, 25 may be changed by a controllable actuator so that the image projector 20, 25 may be configured to project images onto different selected regions 30, 35. Alternatively, such an image projector 20, 25 may be re-oriented so as to continue to project an image onto a selected region 30, 35 as the region 30, 35 moves due to a sensed change in the location of one or more objects placed upon the surface 5.

Alternatively, multiple image projectors 20, 25 may be mounted on the support structure 27, each projector 20, 25 being of a fixed orientation for projecting images along a different fixed axis.

Each image projector 20, 25 may be arranged to project a different image onto each available region 30, 35. The ‘different image’ may be an image, including video images, from different image content or different image sources or it may be a different portion of the same image.

The overhead structure 27, e.g. a cooker extractor hood, supporting the image projectors 20, 25 and the camera 40, may also be used to support loudspeakers to provide an audio output to the user.

A control unit may also be mounted on the structure 27, linked to the image projectors 20, 25, to the camera 40 and to any loudspeakers. The control unit may comprise a data processor and associated data storage configured to implement functionality to process image data output by the camera 40. The control unit may also be configured to control the configuration of the image projectors 20, 25. The control unit may also comprise an interface, such as a wireless communications module and various physical connectors, for receiving images to be projected by the projectors 20, 25 and any associated audio to be played through the loudspeakers.

In an alternative implementation, the control unit may comprise an interface to supply the image data output by the camera 40 for analysis by an external controller. The external controller may be, for example, a controller application executing on a mobile or “smart” phone or general purpose computer operated by the user. The control unit may provide an interface to receive and to process configuration commands or configuration signals in a predetermined set of commands or signals arranged to define or change the configuration of an image projector 20, 25. A controller may thereby generate and transmit to the control unit an appropriate command or signal to select or configure one of the image projectors 20, 25, as described above.

For example, the predetermined set of command may include commands to:
select an image projector 20, 25 to display a defined image or video images;
define the size of an image to be projected by a selected image projector 20, 25;
define the shape of an image to be projected by a selected image projector 20, 25;
define the orientation of an image to be projected by a selected image projector 20, 25;
define the direction of projection of an image by a selected image projector 20, 25 (for example where the image projector 20, 25 may be oriented under actuator control);
define the portion of an image to be projected by a selected image projector 20, 25;
define the acoustic volume of sound to be played by the loudspeakers; and
request capture of an image of the surface 5 by the camera 40 and output of the respective image data.

Particular features may be automated by the control unit. For example, the control unit may be configured to analyse image data output by the camera 40 and to determine one or more available regions 30, 35 of the surface 5, or of an object placed upon the surface 5, onto which images may be projected. The control unit may also be configured to select one or more respective image projectors 20, 25 to be used to project images onto each available region 30, 35. The control unit may pre-configure each selected image projector 20, 25 according to the size and/or shape of the respective regions 30, 35. The control unit may be configured to monitor the image data output by the camera 40 to detect moved or newly placed objects such as pans 10, 15 on the surface. The control unit may be configured to reconfigure the one or more image projectors 20, 25 to project images onto resized, reshaped or relocated regions 30, 35 of the surface 5 or of an object placed upon the surface 5, as required. When a user selects the image(s) to be displayed, the control unit may automatically select one or more of the image projectors 20, 25 to be used to project the selected image(s) having pre-configured the image projectors 20, 25 according to the available regions 30, 35.

Other features as may be controlled by the sending of commands to the control unit via the provided interface, as would be apparent to a person of ordinary skill in the relevant art having in mind the principles described above. Such other features may be implemented by the control unit and any remote controller functionality, wherever implemented.

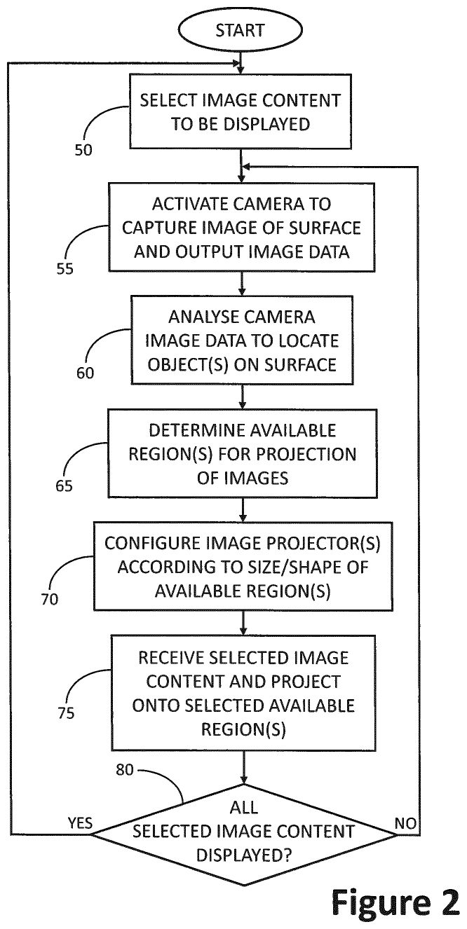

A typical process for operation of the system shown in FIG. 1 will now be described with reference to FIG. 2.

Referring to FIG. 2, a user begins at 50 by selecting a source of images and image content, including video images, to be displayed.

At 55, the camera 40 is activated to capture an image of the surface 5 and to output respective image data. At 60, the image data from the camera 40 is analysed to determine the location of any objects placed upon the surface 5. This enables, at 65, one or more available regions 30, 35 on the surface 5, or a surface of an object placed upon the surface 5, to be identified and their size and/or shape to be determined. Having determined the one or more available regions 30, 35 then, at 70, the one or more image projectors 20, 25 are configured for the projection of images onto a respective region 30, 35 of the appropriate image size and/or shape.

The selected image content is received at 75 and passed to one or more selected image projectors 20, 25 to project onto a respective available region 30, 35. If, at 80, all the selected image content has been displayed, then the process returns to 50 for the user to select further image content to display or for a user to terminate the process. Otherwise, the process returns to 55 to activate the camera 40 and to determine any changes to the available regions 30, 35 due to the sensed position of one or more objects on the surface 5.

The control unit may be arranged to receive image content, including still images, video images or sound, from any conventional source of images and by any conventional interface. For example, images may be stored in a storage device associated with the control unit, transferred from a storage device elsewhere, obtained over a wired or wireless data link, an interface to a wired or wireless network or from a receiver of broadcast signals. The content source may be for example a local content source, such as for example a set top box, a PVR (personal video recorder, also known as a DVR or digital video recorder), a DVD player, a Blu Ray player, a personal computing device such as a laptop or desktop or tablet computer, a cellular phone (including a so-called “smart phone”), a media player, etc., or a remote source connected via a network, including for example the internet. Other sources of image content and techniques for transferring such content to the control unit and to an image projector 20, 25 as would be known to a person of ordinary skill in the relevant art may be applied in the arrangement described above.

Whilst the example above has two projectors 20, 25, in other examples there may be a single projector or more than two projectors. Similarly, whilst the example above has a single camera 40, other examples may use plural cameras. Moreover, other examples may use sensors 40 of a different type, including for example proximity sensors or the like to locate objects on the surface 5, in addition to or instead of a camera 40.

It will be understood that the control unit or a controller referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. An overhead support structure, comprising:
at least one projector for projecting an image onto a surface above which the overhead support structure is mounted in use; and
at least one sensor for sensing a said surface,
wherein the at least one projector is arranged to project an image onto a region of a said surface selected according to an output of the at least one sensor.

2. The overhead support structure according to claim 1, wherein the at least one sensor is arranged to sense the location of an object on a said surface and the at least one projector is configurable to project an image onto a region selected according to a sensed location of one or more objects on a said surface.

3. The overhead support structure according to claim 2, wherein the at least one projector is configurable to project the image onto a different region selected according to a change in the sensed location of one or more objects on a said surface.

4. The overhead support structure according to claim 1, wherein the at least one projector is configurable to adjust a size or a shape of a projected image according to a determined configuration of the selected region.

5. The overhead support structure according to claim 4, arranged such that the configuration of the selected region is determined according to an output of the at least one sensor.

6. The overhead support structure according to claim 1, arranged such that the selected region is a region of a said surface.

7. The overhead support structure according to claim 1, arranged such that the selected region is a region of a surface of an object upon a said surface.

8. The overhead support structure according to claim 1, comprising a plurality of projectors each configurable to project a different image onto each of a plurality of said selected regions.

9. The overhead support structure according to claim 1, wherein the at least one sensor comprises a camera arranged to capture an image of a said surface.

10. The overhead support structure according to claim 1, comprising an interface for receiving image data defining an image to be projected.

11. The overhead support structure according to claim 1, comprising an interface to enable remote configuration of the at least one projector.

12. The overhead support structure according to claim 1, wherein the overhead support structure is an extractor hood for a cooker.

13. A method for projecting an image from an overhead support structure, the method comprising:
sensing a surface below the overhead support structure with a sensor; and
projecting an image onto a region selected according to an output of the sensor.

14. The method according to claim 13, comprising:
sensing the location of an object on the surface; and
projecting an image onto a region selected according to a sensed location of one or more objects on the surface.

15. The method according to claim 14, comprising:
projecting the image onto a different region selected according to a change in the sensed location of one or more objects on the surface.
